(19) United States
(12) Patent Application Publication
(10) Pub. No.: US 2008/0050208 A1
(43) Pub. Date: Feb. 28, 2008

(54) High speed transporter including horizontal belt

(76) Inventors: Barry Kitazumi, Milpitas, CA (US); Mihir Parikh, Los Altos Hills, CA (US); Michael Brain, Monte Sereno, CA (US)

Correspondence Address: CARR & FERRELL LLP, 2200 GENG ROAD, PALO ALTO, CA, 94303, US

(21) Appl. No.: 11/897,024

(22) Filed: Aug. 27, 2007

Related U.S. Application Data
(60) Provisional application No. 60/840,169, filed on Aug. 25, 2006.
(60) Provisional application No. 60/840,131, filed on Aug. 25, 2006.

(51) Int. Cl. B65G 49/07; B65G 15/10; B66C 17/08; B65G 25/00

(52) U.S. Cl. 414/173; 198/817; 414/801; 477/172

(57) ABSTRACT

Systems for transporting an article using horizontal belts are described. Transport sections include a first horizontal belt and a second horizontal belt, and the belts are separated by a distance configured for placement of the article between them. A plurality of horizontal rollers is configured to guide the belts, and a plurality of support protrusions extends from each of the belts. The protrusions are configured to support a weight of the article. Methods for conveying articles using horizontal belts are described. Methods for loading, unloading, and changing the conveyance path of articles are described.

### CROSS REFERENCE TO RELATED APPLICATIONS

This application claims the benefit of U.S. Provisional Patent Application 60/840,169 titled “High Speed Transporter Including Horizontal Belt,” filed Aug. 25, 2006, and 60/840,131, “High Speed Transfers Between Transport Devices” also filed on Aug. 25, 2006, both of which are incorporated herein by reference. This application is related to U.S. patent application Ser. No. 11/406,569, titled “Transport System Including Vertical Rollers,” filed Apr. 18, 2006, which is hereby incorporated by reference.

### BACKGROUND OF THE INVENTION

1. Field of the Invention

The current invention relates to transport systems and methods for conveying articles along a conveyance path, and in some embodiments to conveying substrates for the manufacture of electronic devices in a fabrication facility.

2. Related Art

Transport systems are widely employed in industrial manufacturing facilities to convey articles between work stations. Originally, these systems were manual and workers moved articles by hand or by cart. Modern factories have developed specialized equipment to convey articles automatically. In particular, semiconductor fabrication facilities currently use automated transport systems to move semiconductor wafers during the manufacturing process. Typically, a batch of wafers may be conveyed together in a container known as a FOUP. Semiconductor wafer manufacturers have sought to increase manufacturing productivity by using transport systems that efficiently convey wafers from machine to machine without exposing the wafers to excessive contamination, vibration or to excessive acceleration and deceleration forces. Similar efforts toward increased productivity have been directed toward the fabrication of diverse electronic devices, ranging from substrates for the manufacture of video displays to substrates for the manufacture of energy conversion devices (e.g. photovoltaic cells).

Existing transport systems often employ vehicle-based devices to eliminate vibrations, but the capacity of such a system is limited by the number of vehicles available. To resolve this, transporters are used in which articles are, for example, directly conveyed across the horizontal surface of a transport belt on rollers, or directly on the rollers. One such transport system is shown in FIG. 1A. A common feature of these existing systems is the difficulty of vibrationally isolating the article being conveyed from the surface across which the articles travel. If the surface across which the articles travel is not flat, the articles experience vibration during the conveyance. This source of vibration is a known problem in the semiconductor wafer manufacturing industry. For example, as shown in FIG. 1A, Horizontal Rollers 110 include Surfaces 120 on which a Horizontal Belt 130 rests. Horizontal Belt 130 may be characterized by a Length 140, a Long Cross-Sectional Axis 150, and a Short Cross-Sectional Axis 160. The Long Cross-Sectional Axis 150 and a Short Cross-Sectional Axis 160 are perpendicular to the Length 140, and disposed in horizontal and vertical planes, respectively. The weight of a FOUP 170 is transferred through the Short Cross-Sectional Axis 160 of Horizontal Belt 130 onto Surfaces 120, as is shown in FIG. 1B. Because Horizontal Belt 130 is flexible in the Short Cross-Sectional Axis 160 in which the weight of FOUP 170 is applied and is not continuously supported by Horizontal Rollers 110, the level of Horizontal Belt 130 varies between Horizontal Rollers 110. This unevenness limits the speed at which FOUP 170 can be conveyed while staying within vibration limits.

Another problem with existing transport systems used in the semiconductor wafer manufacturing industry is the difficulty of changing or turning the direction of conveyance of an article, such as a FOUP, without momentarily stopping its motion.

There are, therefore, need for improved systems and methods for conveying articles in manufacturing facilities.

### SUMMARY OF THE INVENTION

The present invention includes, in various embodiments, a transport system for moving articles along a conveyance path that includes straight, horizontal, inclined, and/or declined sections. The articles are conveyed between support protrusions extending from compliant horizontal belts. The compliant feature of the horizontal belts creates a shock-absorbing effect such that the articles being transported experience reduced vibration during the conveyance. The support protrusions may also have a compliant feature, further reducing vibrations during conveyance of the article. These configurations allows the weight of the articles to be partially decoupled from the uneven surfaces across which the horizontal belts travel, resulting in less variation in height of the transported articles during transport as compared to the prior art.

In various embodiments, the shock-absorbing effect of the compliant horizontal belts allows articles, such as Front Opening Unified Pods (FOUPs) including semiconductor wafers, to be transported at greater speeds than in the prior art while still staying within vibration limits. Systems of the invention, therefore, typically reduce the vibration experienced by a FOUP or other article during transport relative to the prior art.

In various embodiments, articles are supported between first and second horizontal belts by one or more support protrusions extending from the first horizontal belt and the second horizontal belt. The weight of the articles is transferred through the support protrusions to the compliant horizontal belts. In various embodiments, the support protrusions, compliant horizontal belts, and rollers are configured to selectively engage and disengage the articles. In some embodiments, the support protrusions are specifically configured to support FOUPs used to transport semiconductor wafers within semiconductor fabrication facilities. In other embodiments, the support protrusions are specifically configured to support substrates for the manufacture of electronic displays (e.g. flat screen displays), energy conversion devices (e.g. photovoltaic cells) or other objects.

A transport system optionally includes several transport sections each including separate compliant horizontal belts. Furthermore, within an individual transport section the compliant horizontal belts are optionally configured in an inclined or declined path, allowing the elevation (height) above ground of the article to be changed during the conveyance. Individual control over belts may also be used to provide for tilting of the conveyance path.

Various embodiments of the invention include a system comprising a first horizontal belt and a second horizontal belt disposed on either side of a conveyance path and configured to convey an article along the conveyance path, a plurality of horizontal rollers configured to guide the first horizontal belt and the second horizontal belt, and a plurality of support protrusions extending from the first horizontal belt and from the second horizontal belt, the plurality of support protrusions configured to support a weight of the article.

Various embodiments of the invention include a transport belt comprising a first surface configured to be coupled to a horizontal roller, the horizontal roller being configured to drive the transport belt in a conveyance path, a support protrusion configured to support the weight of an article being conveyed along the conveyance path by the transport belt, and a compliant material configured to allow the support protrusion to move in response to forces from the article, thus allowing the transport belt to operate as a shock absorber.

Various embodiments of the invention include a method comprising loading an article on a conveyance section, the conveyance section including a first horizontal belt and a second horizontal belt and a plurality of horizontal rollers configured to guide the first horizontal belt and the second horizontal belt, conveying the article along a conveyance path using the first horizontal belt and the second horizontal belt, and unloading the article.

In certain embodiments, the weight of the article between two belts may be at least partially borne by an air bearing. In select embodiments, a three-point kinematic interface can be used to load and/or unload an article.

In some aspects, a system comprises a first belt and a second belt disposed on either side of a conveyance path and configured to convey a FOUP along the conveyance path. The first belt and the second belt are separated by a distance configured for placement of the FOUP between them. A plurality of approximately horizontal rollers is configured to guide the first belt and the second belt, and the FOUP has a lateral freedom of movement of 110 millimeters or less between the belts. A plurality of support protrusions extends from the first belt and from the second belt; the plurality of support protrusions is configured to support the weight of the FOUP.

In other aspects, a system includes a substrate used for manufacturing a device, and a first belt and a second belt disposed on either side of a conveyance path. The belts are configured to convey the substrate along the conveyance path, and the first belt and the second belt are separated by a distance configured for placement of the substrate between the belts. A plurality of approximately horizontal rollers is configured to guide the first belt and the second belt, and a plurality of support protrusions extend from the first belt and from the second belt. The protrusions are configured to support the weight of the substrate.

In further aspects, system includes a first belt and a second belt disposed on either side of a conveyance path and configured to convey a FOUP along the conveyance path. The belts are separated by a distance configured for placement of the FOUP between them, and a plurality of approximately horizontal rollers is configured to guide the belts. A plurality of support protrusions extends from each of the belts; these protrusions are configured to support the weight of the FOUP. A three-point kinematic interface is configured to manipulate the FOUP.

In other aspects, a method comprises loading an article on a transport section. The transport section includes a first horizontal belt and a second horizontal belt, and the belts are separated by a distance configured for placement of the article between them. A plurality of horizontal rollers is configured to guide the belts, and a plurality of support protrusions extends from each of the belts. The protrusions are configured to support a weight of the article. The method also includes conveying the article along a conveyance path using the belts.

Further aspects include a method comprising the loading of an article on a transport section using a three-point kinematic interface. The transport section includes a first horizontal belt and a second horizontal belt, and the belts are separated by a distance configured for placement of a FOUP between them. A plurality of horizontal rollers is configured to guide the belts. The method includes conveying the article along a conveyance path using the belts and unloading the article.

Additional aspects include a system comprising means for loading an article on a transport section. The transport section includes a first horizontal belt and a second horizontal belt, and the belts are separated by a distance configured for placement of the article between them. A plurality of horizontal rollers is configured to guide the belts. The system also includes a means for conveying the article along a conveyance path using the belts, and means for unloading the article. In certain embodiments, the article may include a FOUP, a semiconductor wafer, or a substrate used in the manufacture of a device.

Still further aspects include a system comprising a first belt and a second belt disposed on either side of a conveyance path and configured to convey an article along the conveyance path. The belts are separated by a distance configured for placement of a FOUP between them, such that the FOUP has a lateral freedom of movement of 110 millimeters or less between the belts. Also included is a plurality of approximately horizontal rollers configured to guide the belts, and a plurality of support protrusions extending from the belts. The plurality of support protrusions are configured to support the weight of the article, and at least one of the protrusions includes an article supporting surface that is disposed below part of the first belt.

In additional aspects, a system includes a first belt and a second belt disposed on either side of a conveyance path and configured to convey an article along the conveyance path. The belts are separated by a distance configured for the placement of a FOUP between them, and a plurality of approximately horizontal rollers is configured to guide the belts. A plurality of support protrusions extend from the belts. These protrusions are configured to support the weight of the article, and at least one support protrusion includes an article supporting surface that is disposed below part of the first belt. The system also includes a three-point kinematic interface configured to unload the article from the belts.

Further aspects include a system comprising a first horizontal belt and a second horizontal belt disposed on either side of a conveyance path. The belts are configured to convey an article along the conveyance path. A plurality of approximately horizontal rollers is configured to guide the belts, and a plurality of support protrusions extend from the belts. These protrusions are configured to support the weight of the article.

### BRIEF DESCRIPTION OF THE DRAWINGS

FIG. 1A is a perspective view of a prior art transport system.

FIG. 1B is a portion of FIG. 1A, enlarged for magnification purposes.

FIG. 2 illustrates a transport section including a horizontal belt with support protrusions, according to various embodiments of the invention.

FIG. 3A illustrates a transport section including a horizontal belt with support protrusions, according to various embodiments of the invention.

FIG. 3B is a portion of FIG. 3A, enlarged for magnification purposes.

FIGS. 4A, 4B and 4C illustrate side views of a transport section including compliant horizontal belts, support protrusions and support protrusions with clamps/retaining lips/capture lips, according to various embodiments of the invention.

FIG. 5 illustrates a side view of a transport section including compliant horizontal belts, support protrusions and an article, according to various embodiments of the invention.

FIG. 6 illustrates transport sections with a disengage zone and an engage zone for transferring an article between transport sections, and an air bearing system, according to various embodiments of the invention.

FIG. 7 illustrates a side view of an embodiment of a transport system including a transport section configured to form an inclined or a declined conveyance path, according to various embodiments of the invention.

FIG. 8 illustrates methods of conveying articles, according to various embodiments of the invention.

FIG. 9 illustrates methods of dynamically changing a conveyance path, according to various embodiments of the invention.

FIG. 10 illustrates methods of transitioning from one transport section to another transport section, according to various embodiments of the invention.

FIG. 11A illustrates an example of an air bearing, according to various embodiments of the invention.

FIG. 11B illustrates another example of an air bearing, according to various embodiments of the invention.

FIG. 11C illustrates a further example of an air bearing, according to various embodiments of the invention.

### DETAILED DESCRIPTION OF THE INVENTION

Various embodiments of the invention include improved systems and methods for automatically transporting articles such as FOUPs, substrates for the manufacture of electronic devices, or other articles. For convenience, drawings in this description show embodiments directed toward the transport of FOUPs. However, the invention is not limited to the transport of FOUPs. Some embodiments include the use of compliant horizontal belts that propel articles in a conveyance direction. In comparison with the prior art, the use of compliant horizontal belts allows for more even support of articles and, thus, improved vibration management. In various embodiments, the use of compliant horizontal belts allows the transport of articles along straight, inclined, declined, and/or dynamically changing conveyance paths.

The compliant horizontal belts (transport belts) are optionally disposed between the horizontal rollers and the articles to be transported. In some embodiments, the horizontal belts include a compliant material configured to reduce vibration of articles during transport. This reduced vibration may allow the transport of articles at greater speeds than with prior art systems, while staying within vibration limits.

In various embodiments, articles are supported by protrusions extending approximately horizontally from the compliant horizontal belts. The support protrusions are optionally configured for supporting specific types of articles. For example, some embodiments include support protrusions configured for supporting a FOUP. The size and spacing of the support protrusions is optionally configured such that more than one protrusion from each compliant horizontal belt provides support to an article. In some instances, the support protrusions include a low friction material such as Teflon™ that will allow an article to move slightly on the support protrusions. In some embodiments, the support protrusions include a high friction material that reduces slippage during high acceleration and/or deceleration.

In various embodiments, the compliant horizontal belts include a material configured to flex, deform, bend or otherwise change shape when an article is placed on the support protrusions. For example, in some embodiments the compliant materials are configured to allow a support protrusion to move vertically while supporting the weight of a FOUP during a conveyance.

In various embodiments, the compliant horizontal belts are supported by a low friction sliding surface, an array of finely spaced horizontal rollers or the like. Some embodiments include a clamp, retaining lip or a capture lip configured to restrain movement of articles relative to the transport system. This clamp, retaining lip or capture lip may be part of a support protrusion, be a separate protrusion coupled to a compliant horizontal belt, or be attached to a stationary supporting structure. The clamp, retaining lip or a capture lip is optionally configured to restrain the article during transport and, thus, prevent tipping, sliding or other unintended displacement during acceleration and deceleration.

Conveyance paths determined by the location of the horizontal rollers and/or the compliant horizontal belts may be straight, inclined, declined, and/or dynamically variable. For example, in some embodiments, the horizontal rollers are coupled to movable mounts and are configured to move between various different positions in order to change a conveyance path. In some embodiments the horizontal rollers are configured to move while conveying articles.

Some embodiments feature an air bearing between the belts, often provided by an air bearing generator. The air bearing can provide additional support to the article being transported, and may be particularly useful when transporting wide or flexible articles. Aspects of the air bearing feature non-contact support of the article.

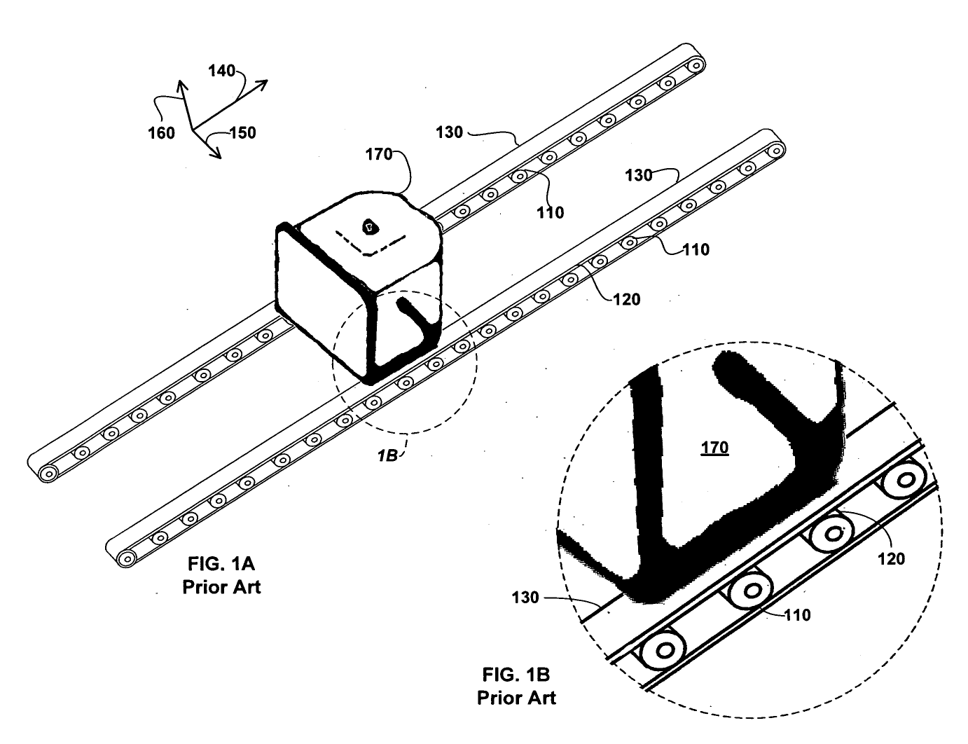

Select embodiments include various apparatus and methods for loading and unloading articles. Loading and/or unloading of articles may optionally be performed with a specially designed interface. For example, by defining a specific mechanical, electrical and software interface, a variety of devices may directly access FOUPs on the transport belts. Example interfaces include a mechanical interface such as the kinematic interface defined by the trade organization SEMI in the document number E57-0600 entitled “Mechanical Specification for Kinematic Couplings used to Align and Support 300 mm Wafer Carriers,” and the electrical interface and software communications interface defined by the SEMI standard E84-0305 entitled “Specification for Enhanced Carrier Handoff Parallel I/O Interface.” The kinematic interface features three kinematic coupling pins on a kinematic mount and configured to mate with three corresponding depressions disposed on the bottom of the FOUP 170 when the FOUP 170 is placed in proper alignment with the kinematic mount. It will be appreciated that the FOUP can also be manipulated from a standard handle on the top of the FOUP. Such a handle is illustrated on the top of FOUP 170 in FIG. 1A. Apparatus and methods for manipulating FOUP 170 using the standard handle are described in U.S. Provisional Application 60/840,131.

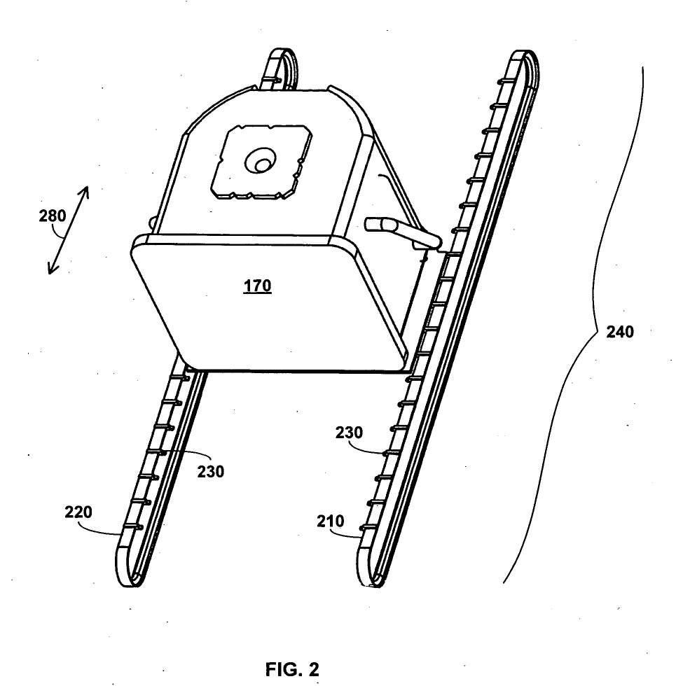

FIG. 2 illustrates a Transport Section generally designated 240 and including a First Horizontal Belt 210, a Second Horizontal Belt 220, and optional Support Protrusions 230. First Horizontal Belt 210 and Second Horizontal Belt 220 are instances of the compliant horizontal belt described above. Transport Section 240 is configured to convey an article such as FOUP 170 and may be configured with multiple instances of separate Transport Sections 240. Transport Section 240 can also be configured to convey an article including a substrate for the manufacture of electronic displays, photovoltaic devices, window glazing or other objects.

First Horizontal Belt 210 and Second Horizontal Belt 220 are each driven separately or jointly in the Conveyance Direction 280 by a plurality of horizontal rollers such as Horizontal Rollers 110 in FIG. 1A (omitted for clarity). The paths along which the horizontal rollers are disposed define a conveyance path through which FOUP 170 travels. Using a variety of transport sections, such as a multiplicity of Transport Section 240, a FOUP 170 can be transported along a complex variety of conveyance paths. Typically, at each end of a transport section, First Horizontal Belt 210 and Second Horizontal Belt 220 wrap around instances of the horizontal rollers.

In typical embodiments, one or more Support Protrusions 230 is attached to each of First Horizontal Belt 210 and to Second Horizontal Belt 220. Support Protrusions 230 extend from First Horizontal Belt 210 and from Second Horizontal Belt 220, and are configured to support the weight of conveyed articles.

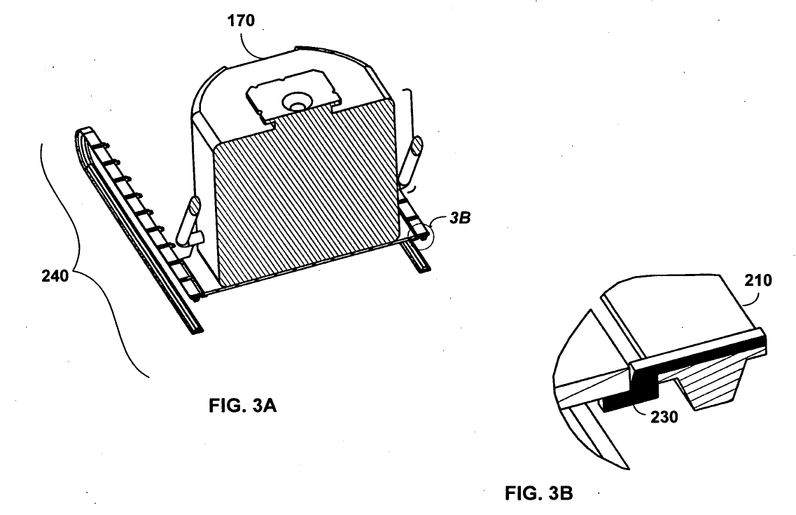

FIGS. 3A and 3B further illustrate Transport Section 240. FIG. 3B is a portion of FIG. 3A enlarged to show detail of one example of First Horizontal Belt 210 and Support Protrusion 230. In this example, First Horizontal Belt 210 has a cross section where a portion of the belt has a substantial thickness in the vertical direction (i.e. Axis 160). Changes in this cross section may optionally be used to control the torsional stiffness of the First Horizontal Belt 210 when subject to a torque about Axis 140. Certain cross sections may also enhance the engagement of the First Horizontal Belt 210 with a drive mechanism (not shown) used to move the First Horizontal Belt 210 along the conveyance path.

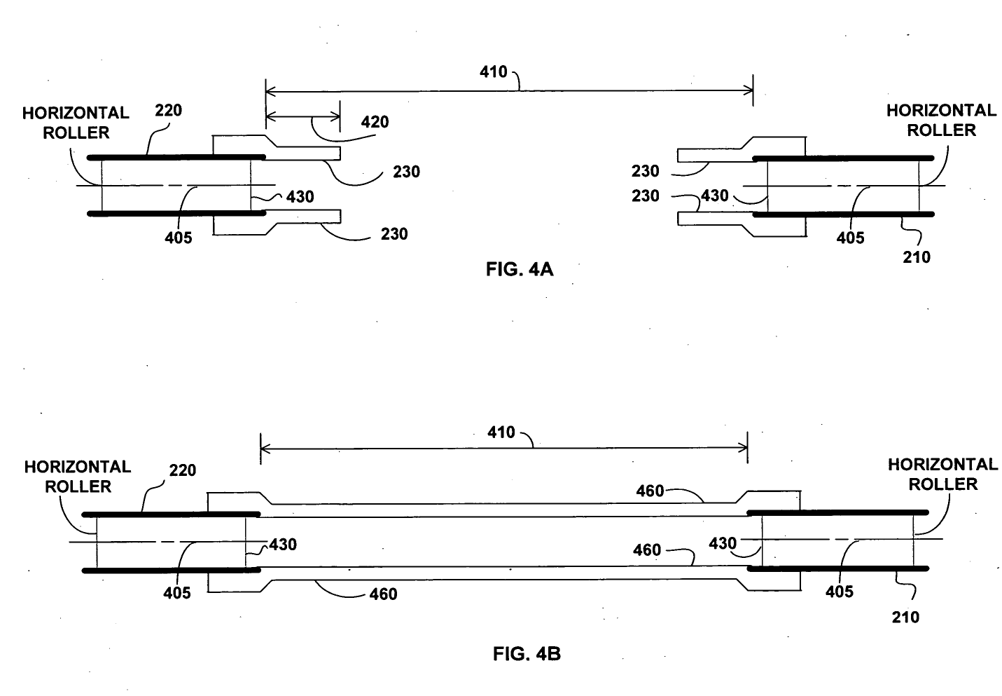

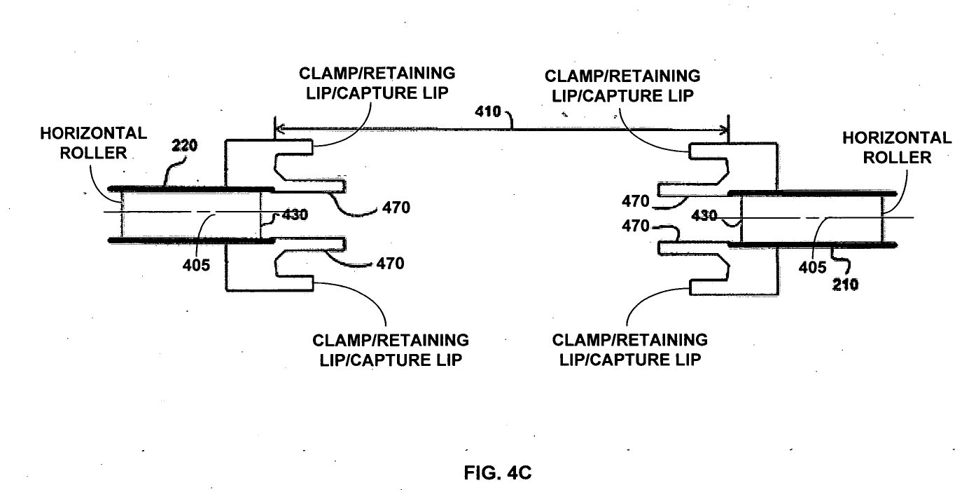

FIG. 4A illustrates a side view of Transport Section 240. This view illustrates the separation of First Horizontal Belt 210 and Second Horizontal Belt 220 by Distance 410. Support Protrusions 230 are configured to support an article, such as FOUP 170, on sections of Length 420. Horizontal Rollers 430 support First Horizontal Belt 210 and Second Horizontal Belt 220. Horizontal Rollers 430 are configured to rotate around a Horizontal Rotation Axis 405, and the return paths for First Horizontal Belt 210 and Second Horizontal Belt 220 are separated by Horizontal Rollers 430.

FIG. 4B illustrates an embodiment in which Support Protrusion 460 extends from First Horizontal Belt 210 to Second Horizontal Belt 220, forming a supporting surface for the conveyed article.

FIG. 4C illustrates an embodiment in which Support Protrusion 470 comprises a clamp/retaining lip/capture lip configured to restrict the movement of an article during conveyance and to prevent tipping during acceleration and deceleration. Support Protrusions 470 extend from First Horizontal Belt 210 and Second Horizontal Belt 220, as depicted in FIG. 4C, and comprise a clamp/retaining lip/capture lip configured to restrain FOUP 170 during a conveyance. In select embodiments, a portion of Support Protrusion 470 can optionally be configured to push-on the article in the direction of conveyance. In alternative embodiments, a clamp, retaining lip or a capture lip may be attached to a separate, optionally stationary, support (not shown).

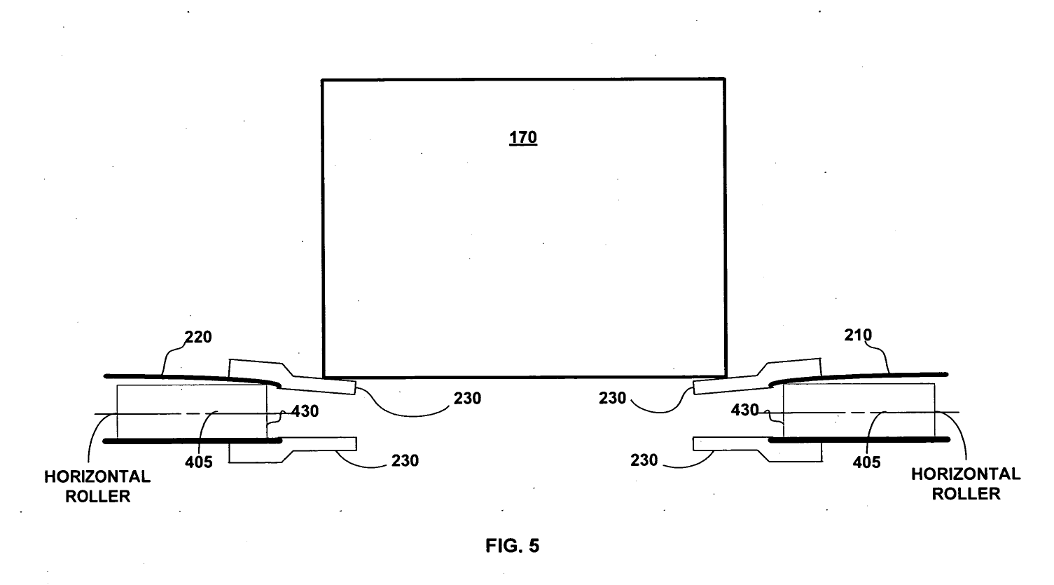

FIG. 5 illustrates a side view of a transport section including compliant horizontal belts, support protrusions and an article such as FOUP 170. FIG. 5 illustrates the deflection of Support Protrusion 230 and First Horizontal Belt 210, and Support Protrusion 230 and Second Horizontal Belt 220, respectively, under the load of FOUP 170. As previously described, First Horizontal Belt 210 and/or Second Horizontal Belt 220 may comprise a material configured to flex, deform, bend or otherwise change shape when an article is placed on the Support Protrusions 230. Thus, the compliant material may be configured to reduce the vibration of articles during transport. This reduced vibration may allow the transport of articles at greater speeds than with prior art systems, while staying within vibration limits. In some embodiments, Support Protrusions 230 may also comprise a compliant material configured to reduce the vibration of articles during transport.

In typical embodiments, Support Protrusions 230 are configured to support the article being transported. Support Protrusions 230 optionally include a low friction coating (not shown), and may be optionally comprised of a low friction material such as Teflon™ to reduce friction between the Support Protrusions 230 and the article during transport.

In some embodiments, the deflection of Support Protrusions 230 under the weight of an article, such as FOUP 170, causes part of an article to be transported below part of First Horizontal Belt 210 and Second Horizontal Belt 220, as shown in FIG. 5. In various embodiments, Transport Section 240 may comprise urethane with a durometer hardness ranging between 25 A and 75 D, silicone, PVC (polyvinyl chloride), rubber or the like. It will be appreciated from the embodiments illustrated herein that many variations from the illustrated embodiments of First Horizontal Belt 210, Second Horizontal Belt 220 and Support Protrusions 230 are within the scope of this disclosure. In addition, First Horizontal Belt 210 is optionally configured identically to Second Horizontal Belt 220.

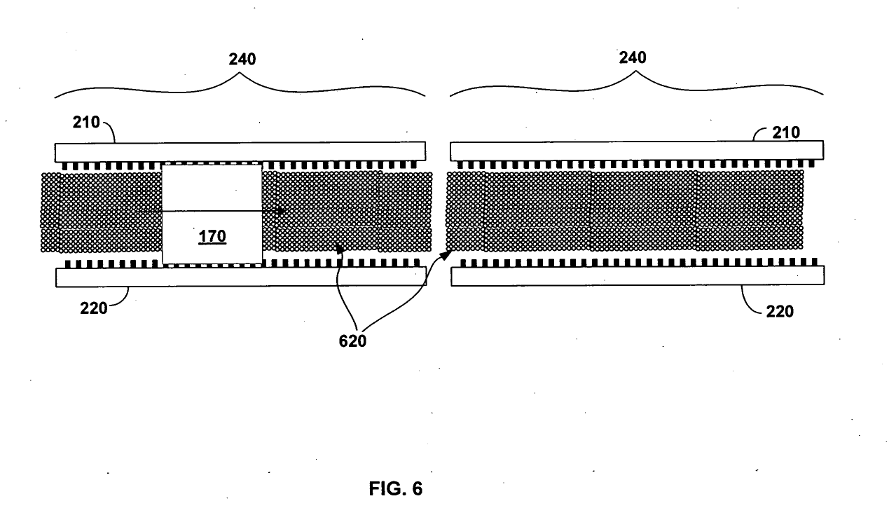

FIG. 6 illustrates transport sections configured for transferring an article between transport sections without excessive vibration or scrubbing. For the purposes of this specification, scrubbing refers to the friction created by the relative motion between the article being conveyed and the transport section. Scrubbing may dislodge particles from the article or the transport section and thus may be a source of undesirable contamination in a manufacturing environment, particularly a microelectronics manufacturing environment. In various embodiments, First Horizontal Belt 210 and Second Horizontal Belt 220 may comprise a disengage zone and an engage zone configured to facilitate the transfer of an article, such as FOUP 170 or a display substrate (not shown), from one Transport Section 240 to another Transport Section 240. In some embodiments, a clamp, retaining lip or a capture lip such as that described with reference to FIG. 4C may be configured to release an article in a disengage zone and then to restrain an article in the beginning of an engage zone.

The embodiment shown in FIG. 6 features multiple Air Bearing Generators 620 associated with each Transport Section 240. Air Bearing Generators 620 create an air bearing (i.e. a uniform cushion of air) below the article (e.g. FOUP 170 in the example shown). This air bearing supports the article without contact, and may be advantageous when transporting wide articles, flexible articles, or articles that are especially sensitive to bending. Air Bearing Generators 620 may optionally be used to improve the transition between two transport sections. Implementations of air bearings are included in U.S. Pat. Nos. 5,810,155 and 6,523,572, and published US Patent Application 2006/0054774A1, all of which are incorporated herein by reference.

In some embodiments, Air Bearing Generators 620 are configured to provide support in a central region of the article being transported. In various embodiments, the article comprises a substrate including glass, polymer, or semiconductor material. The article may also comprise substrates for the manufacture of liquid crystal, organic light emitting diode or other types of display devices, a memory substrate (such as a hard drive platter substrate or an optical storage device substrate), a photovoltaic device substrate, a battery substrate, or the like. By supporting the central region of the article, Air Bearing Generators 620 may reduce stress on the article, and prevent damage or breakage due to bending caused by uneven support across the width of the article between the transport, belts. In some embodiments, the Air Bearing Generators 620 may support an article such as a substrate characterized by an area less than 1 square meter, between 1 square meter and 5 square meters, between 5 square meters and 6 square meters, or between 6 square meters and 7 square meters.

Air Bearing. Generators 620 may also reduce physical contact between the conveyance section 240 and the article 170 in comparison with alternative support members such as rollers, consequently reducing friction and vibration. Reduced contact and friction may also reduce contamination of the article and the ambient environment, for example by minimizing scrubbing.

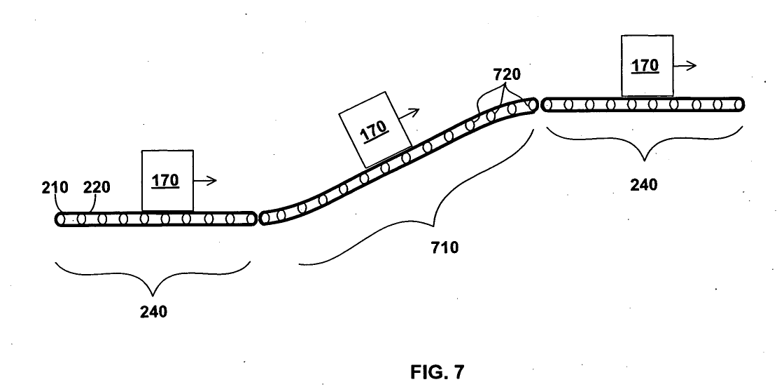

FIG. 7 illustrates an embodiment of a transport system including a transport section configured to form an inclined or a declined conveyance path. Transport Section 710 is optionally an embodiment of Transport Section 240 in which Horizontal Rollers 720 may be raised or lowered to guide First Horizontal Belt 210 and/or Second Horizontal Belt 220 along an inclined or declined path. Thus, the elevation of FOUP 170 above the ground may be changed during the conveyance by a Transport Section 710. In various embodiments, Transport Section 710 includes inclines and declines of greater than approximately 10, 25, 45, or 60 degrees. By arranging several of Transport Section 710 and Transport Section 240 together, a complex variety of straight, inclined, and declined conveyance paths can be configured. Other embodiments of the invention provide for raising or lowering First Horizontal Belt 210 independently of Second Horizontal Belt 220, such that the belts are at different heights, resulting in a tilting of the object being transported. Tilted configurations such as these can optionally include the tilting of the axes of the rollers supporting one or both Horizontal Belts. In some embodiments of these tilted configurations, the roller axes of First Horizontal Belt 210 can be adjusted to point toward Second Horizontal Belt 220, and the roller axes of Second Horizontal Belt 220 can be adjusted to point toward First Horizontal Belt 210, in such a way that the axes of two opposing rollers remain coplanar.

In some embodiments, Transport Section 240 (configured to form a straight path) and/or Transport Section 710 (configured to form an inclined or a declined path) may be coupled to a transport section using vertically-oriented belts. Thus, a transport system configured to convey articles such as FOUP 170 may comprise combinations of horizontal belts of the present invention with vertically-oriented belts. In one example, a transport system may be configured with a first section comprising vertically-oriented belts to convey articles along a path of constant elevation above the ground, a second section comprising a Transport Section 710 to raise or lower the elevation of the conveyed article, followed by a third section comprising vertically-oriented belts to continue the conveyance of the articles along a path of constant elevation. In optional embodiments, each of the first, second, and third sections described above may be any one of Transport Section 240, Transport Section 710, or a transport section comprising vertically-oriented belts.

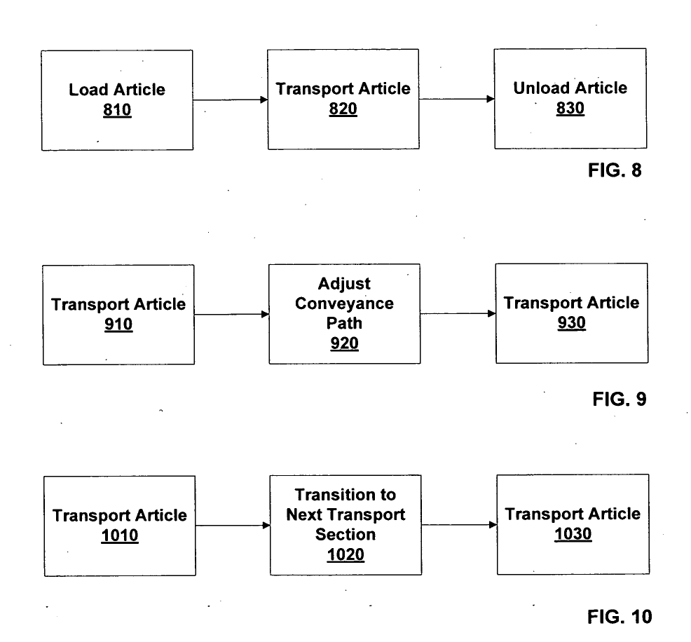

FIG. 8 illustrates methods of conveying articles, according to various embodiments. In these methods, an article is loaded onto a transport system such as those describe elsewhere herein, transported and unloaded. In a Load Article Step 810, articles to be conveyed are placed on a transport section such as Transport Sections 240. The articles are optionally placed at a section of Transport Section 240 specifically configured for loading and unloading articles.

In a Transport Article Step 820, the article loaded in Load Article Step 810 is conveyed in the conveyance direction. This conveyance is optionally performed at a greater speed and/or a lower vibration rate than is possible in systems of the prior art. Transport Article Step 820 optionally includes directing the article along an inclined, declined or tilted path such as that illustrated in FIG. 7. The inclined, declined, and/or tilted paths are optionally traversed without slowing or without momentarily stopping the article.

In an Unload Article Step 830, the article is removed from the transport system. This removal optionally occurs at a location configured for loading and/or unloading of the article, as discussed elsewhere herein.

In some embodiments, Load Article Step 810 and/or Unload Article Step 830 can optionally be performed using a three point kinematic interface, as described elsewhere herein.

FIG. 9 illustrates methods of dynamically changing a conveyance path, according to various embodiments of the invention. The methods illustrated in FIG. 9 are optionally performed using the Transport Section 710 or Transport Section 240, as illustrated in FIG. 7.

In a Transport Article Step 910, an article, such as FOUP 170, is transported as in Transport Article Step 820. In Adjust Conveyance Path Step 920, a conveyance path for the article is changed by moving First Horizontal. Belt 210 and/or Second Horizontal Belt 220. This movement may be in the horizontal or vertical plane, or even in a combination of horizontal and vertical planes. In Transport Article Step 930, the article is again conveyed, as in Transport Article Step 910.

FIG. 10 illustrates methods of transitioning from one transport section to another transport section, according to various embodiments of the invention. The methods illustrated in FIG. 10 are optionally performed using Transport Section 240, Transport Section 710, or performed using a transport section comprising a vertically-oriented belt.

In a Transport Article Step 1010, an article, such as FOUP 170, is transported using a first transport section comprising a horizontal belt as described above. In a Transition to Next Transport Section Step 1020, the article is transferred to a second transport section, optionally comprising a vertically-oriented belt. In Transport Article Step 1030, the article is again conveyed, this time using the second transport section. Transfer of the article between sections may be enhanced by the use of one or more air bearings.

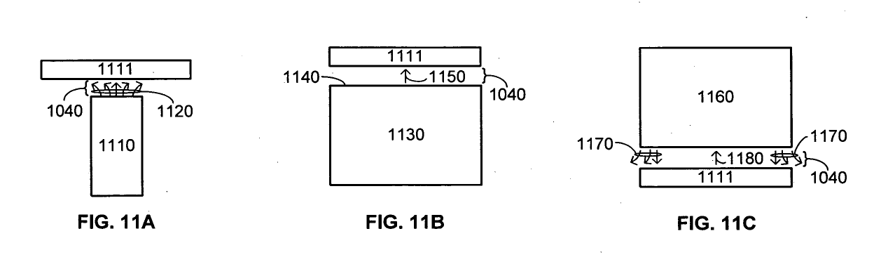

FIG. 11A illustrates various embodiments of an Air Bearing Generator 1110. In these embodiments, the Air Bearing Generator 1110 may be configured to generate an Air Bearing 1040 by generating an upward Air Stream 1120. The upward Air Stream 1120 forms the Air Bearing 1040 by providing physical support to an Article 1111 when the article travels above the Air Bearing 1040 along the conveyance path. The Air Bearing Generator 1110 may be configured to emit one or more Air Streams 1120 emanating from one or more holes in a tube or support member. A velocity and quantity of air within the one or more Air Streams 1120 determines a level of support provided by the one or more Air Streams 1120 to the article.

The Air Bearing Generator 1110 may optionally be configured to output a significantly reduced Air Stream 1120 or no Air Stream 1120 when the Article 1111 is not in a path of the Air Stream 1120. For example, the Air Bearing Generator 1110 may be configured to only output the Air Stream 1120 directly upward if the Article 1111 is above the Air Bearing 1040, and to output a reduced Air Stream 1120 when there is no Article 1111 above the Air Bearing 1040. In some embodiments, turbulent limited orifices, such as those described in U.S. Pat. No. 6,523,572 entitled “Apparatus for Inducing Forces by Fluid Injection” which is incorporated herein by reference, may be used to limit the Air Stream 1120 when there is no Article 1111 above the Air Bearing 1040.

FIG. 11B illustrates an alternative embodiment of an Air Bearing Generator 1130 utilizing ultrasonic levitation. U.S. Pat. No. 5,810,155 entitled “Object Levitating Apparatus Object Transporting Apparatus and Object Levitating Bearing Along with an Object Levitating Process and Object Transporting Process,” which is incorporated herein by reference, discloses various embodiments of an object levitating apparatus using ultrasonic excitation. Ultrasonic levitation may typically be used to levitate an Article 1111, which may be characterized by thicknesses of approximately 1 mm to 2 mm, above a Support Surface 1140. Ultrasonic levitation uses ultrasonic waves generated between the Support Surface 1140 and the Article 1111 to drive airflow into a space between the Article 1111 and the Support Surface 1140, and to inhibit air from flowing out of the space between the Article 1111 and the Support Surface 1140. In this way, the Air Bearing Generator 1130 creates an air pressure differential between the Article 1111 and the Support Surface 1140 compared to the ambient air pressure around the Article 1111. The air pressure differential creates an Upward Force 1150 that forms an Air Bearing 1040 that in turn levitates the Article 1111 above the Support Surface 1140.

FIG. 11C illustrates alternative embodiments of an Air Bearing Generator 1160 utilizing a Venturi vacuum support system. A Venturi vacuum support system supports an Article 1111 such as a substrate from above rather than from underneath. As an Air Stream 1170 emanates downward through a Venturi nozzle disposed in the Air Bearing Generator 1160, a vortex or Venturi is created in the center of the Venturi nozzle. The center of the Venturi or vortex is characterized by a lower air pressure than the ambient air pressure, thereby creating a localized vacuum and a Suction Force 1180 tending to lift the Article 1111 upward toward the center of the Venturi nozzle. The Air Stream 1170 which escapes below the Venturi nozzle in the Air Bearing Generator 1170 forms an Air Bearing 1040. The Air Bearing 1040 creates an equilibrium between the upward Suction Force 1180 and a downward force caused by the Air Stream 1170 emanating from the Venturi nozzle within the Air Bearing Generator 1160.

Several embodiments are specifically illustrated and/or described herein. However, it will be appreciated that modifications and variations are covered by the above teachings and within the scope of the appended claims without departing from the spirit and intended scope thereof. For example, while the transportation of FOUPs in semiconductor manufacturing have been used herein as an illustrative example, systems and methods of the invention may be configured for transporting alternative materials, such as for example, substrates for the manufacture of liquid crystal, plasma, organic light emitting diode or other types of display devices. Further, the compliant horizontal belts and horizontal rollers discussed herein need not be perfectly horizontal.

The embodiments discussed herein are illustrative of the present invention. As these embodiments of the present invention are described with reference to illustrations, various modifications or adaptations of the methods and or specific structures described may become apparent to those skilled in the art. All such, modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A system comprising:
a first belt and a second belt disposed on either side of a conveyance path and configured to convey a FOUP along the conveyance path, the first belt and the second belt separated by a distance configured for placement of the FOUP between the first belt and the second belt;
a plurality of approximately horizontal rollers configured to guide the first belt and the second belt, wherein the FOUP has a lateral freedom of movement of 110 millimeters or less between the first belt and the second belt; and
a plurality of support protrusions extending from the first belt and from the second belt, the plurality of support protrusions configured to support a weight of the FOUP.

2. The system of claim 1, wherein the first belt and the second belt are a first horizontal belt and a second horizontal belt respectively, and are stiff along a horizontal cross-sectional axis and less stiff in a vertical cross-sectional axis.

3. The system of claim 1, wherein the first belt and the second belt include a compliant material configured to reduce vibration of the article as the article is conveyed along the conveyance path.

4. The system of claim 1, wherein the first belt and the second belt include a compliant material configured to allow movement of a member of the plurality of support protrusions responsive to the weight of the FOUP.

5. The system of claim 1, wherein the first belt and the second belt are configured to move at different speeds.

6. The system of claim 1, wherein the plurality of horizontal rollers is disposed such that the conveyance path is declined, inclined, or tilted.

7. The system of claim 1, wherein the plurality of support protrusions includes an essentially continuous support protrusion along a length of the first belt or the second belt.

8. The system of claim 1, wherein the first belt or the second belt includes a part that extends above a bottom of the FOUP.

9. The system of claim 1, wherein the first belt is coupled to a capture lip, the capture lip configured to restrict vertical movement of the FOUP.

10. The system of claim 1, further including a capture lip positioned above the first belt, the capture lip configured to restrict vertical movement of the FOUP.

11. The system of claim 1, wherein the plurality of horizontal rollers is configured to move vertically in order to change the conveyance path of the article.

12. The system of claim 1, wherein the first belt and the second belt are each supported by more than two horizontal rollers.

13. The system of claim 1, wherein a member of the plurality of support protrusions includes a FOUP supporting surface that is disposed below a part of the first belt.

14. The system of claim 1, further including a three-point kinematic interface configured to manipulate the FOUP.

15. The system of claim 1, wherein the first belt is configured to fit into a groove or notch within a member of the plurality of horizontal rollers.

16. A system comprising:
a substrate used for manufacturing a device;
a first belt and a second belt disposed on either side of a conveyance path and configured to convey the substrate along the conveyance path, the first belt and the second belt separated by a distance configured for placement of the substrate between the first belt and the second belt;
a plurality of approximately horizontal rollers configured to guide the first belt and the second belt; and
a plurality of support protrusions extending from the first belt and from the second belt, the plurality of support protrusions configured to support a weight of the substrate.

17. The system of claim 16, wherein the device is a component of a display.

18. The system of claim 16, wherein the device is a component of an energy conversion apparatus.

19. The system of claim 16, wherein the first belt and/or the second belt includes a compliant material configured to allow movement of a member of the plurality of support protrusions responsive to the weight of the substrate.

20. The system of claim 16, wherein the first belt and/or the second belt includes a part that extends above a bottom of the substrate.

21. The system of claim 16, wherein the first belt is coupled to a capture lip, the capture lip configured to restrict vertical movement of the substrate.

22. A system comprising:
a first belt and a second belt disposed on either side of a conveyance path and configured to convey a FOUP along the conveyance path, the first belt and the second belt separated by a distance configured for placement of the FOUP between the first belt and the second belt;
a plurality of approximately horizontal rollers configured to guide the first belt and the second belt;
a plurality of support protrusions extending from each of the first belt and the second belt, the plurality of support protrusions configured to support a weight of the FOUP; and
a three-point kinematic interface configured to manipulate the FOUP.

23. The system of claim 22, wherein the three-point kinematic interface is further configured to load and unload the FOUP.

24. The system of claim 22 wherein the distance between the first belt and the second belt is greater than the width of the FOUP.

25. A method comprising:
loading an article on a transport section, the transport section including
a first horizontal belt and a second horizontal belt, the first horizontal belt and the second horizontal belt separated by a distance configured for placement of the article between the first horizontal belt and the second horizontal belt;
a plurality of horizontal rollers configured to guide the first horizontal belt and the second horizontal belt;
a plurality of support protrusions extending from each of the belts, the protrusions configured to support a weight of the article, and
conveying the article along a conveyance path using the first horizontal belt and the second horizontal belt.

26. The method of claim 25, wherein loading includes the use of a three-point kinematic interface.

27. The method of claim 25, wherein the article includes a substrate.

28. The method of claim 25, wherein a member of the plurality of support protrusions includes an article supporting surface that is disposed below a part of the first belt.

29. The method of claim 25, wherein the transport section further includes the use of one or more air bearing generators disposed between the first and second belts, the air bearing generators capable of generating an air bearing, the air bearing capable of supporting at least some of the weight of the article.

30. A method comprising:
loading a FOUP on a transport section using a three-point kinematic interface, the transport section including:
a first horizontal belt and a second horizontal belt, the first horizontal belt and the second horizontal belt separated by a distance configured for placement of a FOUP between the first horizontal belt and the second horizontal belt;
a plurality of horizontal rollers configured to guide the first horizontal belt and the second horizontal belt;
conveying the FOUP along a conveyance path using the first horizontal belt and the second horizontal belt; and
unloading the FOUP.

31. A system comprising:
means for loading an article on a transport section, the transport section including
a first horizontal belt and a second horizontal belt, the first horizontal belt and the second horizontal belt separated by a distance configured for placement of the article between the first horizontal belt and the second horizontal belt,
a plurality of horizontal rollers configured to guide the first horizontal belt and the second horizontal belt, and
a plurality of support protrusions extending from each of the belts, the protrusions configured to support a weight of the article;
means for conveying the article along a conveyance path using the first horizontal belt and the second horizontal belt; and
means for unloading the article.

32. The system of claim 31, wherein the means for unloading the article comprises a three-point kinematic interface.

33. A system comprising:
a first belt and a second belt disposed on either side of a conveyance path and configured to convey a FOUP along the conveyance path, the first belt and the second belt separated by a distance configured for placement of the FOUP between the first belt and the second belt, wherein the FOUP has a lateral freedom of movement of 110 millimeters or less between the first belt and the second belt;
a plurality of approximately horizontal rollers configured to guide the first belt and the second belt; and
a plurality of support protrusions extending from the first belt and from the second belt, the plurality of support protrusions configured to support a weight of the FOUP, wherein a member of the plurality of support protrusions includes an article supporting surface that is disposed below a parts of the first belt.

34. A system comprising:
a first belt and a second belt disposed on either side of a conveyance path and configured to convey a FOUP along the conveyance path, the first belt and the second belt separated by a distance configured for placement of the FOUP between the first belt ant the second belt;
a plurality of approximately horizontal rollers configured to guide the first belt and the second belt;
a plurality of support protrusions extending from the first belt and from the second belt, the plurality of support protrusions configured to support a weight of the FOUP, wherein a member of the plurality of support protrusions includes an article supporting surface that is disposed below a part of the first belt; and
a three-point kinematic interface configured to unload the FOUP from the first belt and the second belt.

35. A system comprising:
a first horizontal belt and a second horizontal belt disposed on either side of a conveyance path and configured to convey an article along the conveyance path;
a plurality of approximately horizontal rollers configured to guide the first horizontal belt and the second horizontal belt; and
a plurality of support protrusions extending from the first horizontal belt and from the second horizontal belt, the plurality of support protrusions configured to support a weight of the article.

36. The system of claim 35, further including the article, the article including a FOUP, a semiconductor wafer, or a substrate.

37. The system of claim 35, wherein the first horizontal belt and the second horizontal belt include a compliant material configured to reduce vibration of the article as the article is conveyed along the conveyance path.

38. The system of claim 35, wherein the first horizontal belt and the second horizontal belt include a compliant material configured to allow movement of a member of the plurality of support protrusions responsive to the weight of the article.

39. The system of claim 35, wherein the plurality of horizontal rollers is disposed such that the conveyance path is declined, inclined, or tilted.

40. The system of claim 35, further including a three-point kinematic interface, configured to manipulate the article between the first horizontal belt and the second horizontal belt.

41. The system of claim 35, wherein one or more of the first and/or second belts has a cross section having a controlled torsional stiffness about an axis of the belt parallel to the conveyance direction.

42. The system of claim 35, further comprising one or more air bearing generators disposed between the first and second belts, the air bearing generators capable of generating an air bearing, the air bearing capable of substantially supporting at least some of the weight of the article.

43. The system of claim 42, wherein one or more protrusions has at least a portion that sufficiently extends above a bottom edge of the article to provide a normal force to the article in the direction of conveyance.

44. The system of claim 35, wherein one or more first protrusions on any of the first and second belts is connected to a second protrusion on the opposite belt, the second protrusion disposed substantially across the conveyance path from the first protrusion.

45. The system of claim 44, wherein the first and second protrusions are rigidly connected.

46. A system comprising:
a first transport section including a first horizontal belt and a second horizontal belt separated by a distance configured for placement of an article between the first horizontal belt and the second horizontal belt;
a second transport section including a third belt and a fourth belt separated by the distance; and
an air bearing generator disposed between the first and second transport sections and configured to provide an air bearing capable of at least partially supporting the article.
